(19) United States
(12) Patent Application Publication
(10) Pub. No.: US 2008/0262177 A1
(43) Pub. Date: Oct. 23, 2008

(54) Process for producing fluoroelastomers

(76) Inventor: Donald F. Lyons, Wilmington, DE (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/214,845

(22) Filed: Jun. 23, 2008

Related U.S. Application Data
(63) Continuation-in-part of application No. 11/982,903, filed on Nov. 6, 2007, now abandoned.
(60) Provisional application No. 60/875,773, filed on Dec. 19, 2006.

(51) Int. Cl. C08F 2/22

(52) U.S. Cl. 526/193

(57) ABSTRACT

A novel emulsion polymerization process for the production of fluoroelastomers is disclosed wherein the dispersing agent is a phosphate ester anionic surfactant of the formula [CH₃—(CH₂)ₙ—O]ₓ—PO(OM)₍₃₋ₓ₎ where n is an integer from 1 to 8, or mixtures thereof, x is 1 or 2 and M is a cation having a valence of 1.

### CROSS REFERENCE TO RELATED APPLICATIONS

This application is a continuation-in-part of U.S. application Ser. No. 11/982,903, filed Nov. 6, 2007 which claims the benefit of U.S. Provisional Application No. 60/875,773 filed Dec. 19, 2006.

### FIELD OF THE INVENTION

This invention pertains to a novel emulsion polymerization process for the production of fluoroelastomers wherein a certain class of hydrocarbon phosphate anionic surfactant is used as the dispersing agent.

### BACKGROUND OF THE INVENTION

Fluoroelastomers having excellent heat resistance, oil resistance, and chemical resistance have been used widely for sealing materials, containers and hoses.

Production of such fluoroelastomers by emulsion and solution polymerization methods is well known in the art; see for example U.S. Pat. Nos. 4,214,060 and 4,281,092. Generally, fluoroelastomers are produced in an emulsion polymerization process wherein a water-soluble polymerization initiator and a relatively large amount of surfactant are employed. The surfactant most often used for such processes has been ammonium perfluorooctanoate (C-8). Fluoroelastomers prepared in such processes leave the reactor in the form of a dispersion.

While C-8 works very well as a surfactant in the polymerization process, it is relatively expensive, and its future commercial availability is uncertain. Thus, it would be desirable to find other surfactants effective for use in the emulsion polymerization of fluoroelastomers.

Efforts to replace C-8 have focused on other expensive anionic fluorosurfactants such as 1) F—(CF₂CF₂)ₙCH₂CH₂—OSO₃M, where n is an integer from 2-8, or mixtures thereof, and M is an alkali metal cation, hydrogen ion or ammonium ion (U.S. Pat. No. 4,524,197); 2) F—(CF₂CF₂)ₙCH₂CH₂—SO₃M, where n is an integer from 2-8, or mixtures thereof, and M is an alkali metal cation, hydrogen ion or ammonium ion (U.S. Pat. No. 4,380,618); and 3) C₆F₁₃CH₂CH₂SO₃M wherein M is a cation having a valence of 1 (U.S. Pat. No. 5,688,884). Such fluorinated surfactants are effective in forming stable dispersions of highly fluorinated fluoroelastomer latex particles during the emulsion polymerization process because of the highly fluorinated structure of the surfactants.

U.S. Pat. No. 6,512,063 B2 discloses an emulsion polymerization process for the production of fluoroelastomers wherein a hydrocarbon sulfonate is employed as the dispersing agent.

WO 2005/063827 A1 discloses polymerization of fluoropolymers in the presence of a branched hydrocarbon surfactant of the formula R₁R₂R₃C-L-M, wherein R₁ and R₂ are the same or different alkyl or alkenyl groups, R₃ is a hydrogen atom, alkyl or alkenyl group and wherein the total number of carbon atoms on R₁ to R₃ is 2-25, M is a monovalent cation and L is —SO₃⁻, —OSO₃⁻, —PO₃⁻, —OPO₃⁻, or COO⁻.

### SUMMARY OF THE INVENTION

Surprisingly, it has been found that certain straight chain hydrocarbon phosphate ester surfactants may be used to manufacture highly fluorinated fluoroelastomers. One aspect of the present invention provides an emulsion polymerization process for the production of fluoroelastomers, said fluoroelastomers having at least 53 weight percent fluorine, comprising:

(A) charging a reactor with a quantity of an aqueous solution comprising a phosphate ester anionic surfactant of the formula [CH₃—(CH₂)ₙ—O]ₓ—PO(OM)₍₃₋ₓ₎ wherein n is an integer from 1 to 8, or mixtures thereof, x is 1 or 2, and M is a cation having a valence of 1, said aqueous solution containing less than 100 ppm fluorosurfactant;

(B) charging the reactor with a quantity of a monomer mixture, said monomer mixture comprising i) from 25 to 70 weight percent, based on total weight of the monomer mixture, of a first monomer, said first monomer selected from the group consisting of vinylidene fluoride and tetrafluoroethylene, and ii) between 75 and 30 weight percent, based on total weight of the monomer mixture, of one or more additional copolymerizable monomers, different from said first monomer, wherein said additional monomer is selected from the group consisting of fluorine-containing olefins, fluorine-containing vinyl ethers, hydrocarbon olefins and mixtures thereof; and

(C) polymerizing said monomers in the presence of a free radical initiator to form a fluoroelastomer dispersion while maintaining said reaction medium at a pH between 1 and 7, at a pressure between 0.5 and 10 MPa, and at a temperature between 25° C. and 130° C.

### DETAILED DESCRIPTION OF THE INVENTION

The present invention is directed to an emulsion polymerization process for producing a fluoroelastomer. By “fluoroelastomer” is meant an amorphous elastomeric fluoropolymer. The fluoropolymer may be partially fluorinated or perfluorinated, so long as it contains at least 53 percent by weight fluorine, preferably at least 64 wt. % fluorine. Fluoroelastomers made by the process of this invention contain between 25 to 70 weight percent, based on the weight of the fluoroelastomer, of copolymerized units of a first monomer which may be vinylidene fluoride (VF₂) or tetrafluoroethylene (TFE). The remaining units in the fluoroelastomers are comprised of one or more additional copolymerized monomers, different from said first monomer, selected from the group consisting of fluorine-containing olefins, fluorine-containing vinyl ethers, hydrocarbon olefins and mixtures thereof.

According to the present invention, fluorine-containing olefins copolymerizable with the first monomer include, but are not limited to, vinylidene fluoride, hexafluoropropylene (HFP), tetrafluoroethylene (TFE), 1,2,3,3,3-pentafluoropropene (1-HPFP), chlorotrifluoroethylene (CTFE) and vinyl fluoride.

The fluorine-containing vinyl ethers employed in the present invention include, but are not limited to perfluoro(alkyl vinyl)ethers. Perfluoro(alkyl vinyl)ethers (PAVE) suitable for use as monomers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl)ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl)ethers includes those ethers wherein n is 0 or 1 and R_{f} contains 1-3 carbon atoms. Examples of such perfluorinated ethers include perfluoro(methyl vinyl)ether (PMVE) and perfluoro(propyl vinyl)ether (PPVE). Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluoro(alkyl vinyl)ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5.
Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers prepared by the process of the invention, the PAVE content generally ranges from 25 to 75 weight percent, based on the total weight of the fluoroelastomer. If perfluoro(methyl vinyl)ether is used, then the fluoroelastomer preferably contains between 30 and 55 wt. % copolymerized PMVE units.

Hydrocarbon olefins useful in the fluoroelastomers prepared by the process of this invention include, but are not limited to ethylene (E) and propylene (P). If copolymerized units of a hydrocarbon olefin are present in the fluoroelastomers prepared by the process of this invention, hydrocarbon olefin content is generally 4 to 30 weight percent

The fluoroelastomers prepared by the process of the present invention may also, optionally, comprise units of one or more cure site monomers. Examples of suitable cure site monomers include: i) bromine-containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl)ether; and ix) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂ (R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH-Z-CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1(ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Useful nitrile-containing cure site monomers include those of the formulas shown below.

CF₂═CF—O(CF₂)ₙ—CN (VI)

where n=2-12, preferably 2-6;

CF₂═CF—O[CF₂—CF(CF₃)—O]ₙ—CF₂—CF(CF₃)—CN (VII)

where n=0-4, preferably 0-2;

CF₂═CF—[OCF₂CF(CF₃)]_{X}—O—(CF₂)ₙ—CN (VIII)

where x=1-2, and n=1-4; and

CF₂═CF—O—(CF₂)ₙ—O—CF(CF₃)CN (IX)

where n=2-4. Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (X)

i.e. perfluoro(8-cyano-5-methyl-3,6-dioxa-1-octene) or 8-CNVE.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent 2,067,891 and European Patent 0784064A1. A suitable triene is 8-methyl-4-ethylidene-1,7-octadiene.

Of the cure site monomers listed above, preferred compounds, for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; bromotrifluoroethylene and 8-CNVE. When the fluoroelastomer will be cured with a polyol, 2-HPFP or perfluoro(2-phenoxypropyl vinyl)ether is the preferred cure site monomer. When the fluoroelastomer will be cured with a tetraamine, bis(aminophenol) or bis(thioaminophenol), 8-CNVE is the preferred cure site monomer.

Units of cure site monomer, when present in the fluoroelastomers manufactured by the process of this invention, are typically present at a level of 0.05-10 wt. % (based on the total weight of fluoroelastomer), preferably 0.05-5 wt. % and most preferably between 0.05 and 3 wt. %.

Specific fluoroelastomers which may be produced by the process of this invention include, but are not limited to those having at least 58 wt. % fluorine and comprising copolymerized units of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl)ether, ethylene and 4-iodo-3,3,4,4-tetrafluorobutene-1; xi) tetrafluoroethylene, propylene and vinylidene fluoride; xii) tetrafluoroethylene and perfluoro(methyl vinyl)ether; xiii) tetrafluoroethylene, perfluoro(methyl vinyl)ether and perfluoro(8-cyano-5-methyl-3,6-dioxa-1-octene); xiv) tetrafluoroethylene, perfluoro(methyl vinyl)ether and 4-bromo-3,3,4,4-tetrafluorobutene-1; xv) tetrafluoroethylene, perfluoro(methyl vinyl)ether and 4-iodo-3,3,4,4-tetrafluorobutene-1; and xvi) tetrafluoroethylene, perfluoro(methyl vinyl)ether and perfluoro(2-phenoxypropyl vinyl)ether.

Additionally, iodine-containing endgroups, bromine-containing endgroups or mixtures thereof may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use in the process of this invention include those disclosed in U.S. Pat. No. 3,707,529. Examples of such agents include isopropanol, diethylmalonate, ethyl acetate, carbon tetrachloride, acetone and dodecyl mercaptan.

Cure site monomers and chain transfer agents may be added to the reactor neat or as solutions. In addition to being introduced into the reactor near the beginning of polymerization, quantities of chain transfer agent may be added throughout the entire polymerization reaction period, depending upon the desired composition of the fluoroelastomer being produced, the chain transfer agent being employed, and the total reaction time.

Surprisingly, it has been found that a straight chain phosphate ester surfactant of the formula [CH₃—(CH₂)ₙ—O]ₓ—PO(OM)₍₃₋ₓ₎ may be employed as the dispersing agent in the polymerization process of this invention. In these formulae n is an integer from 1 to 8, or mixtures thereof, x is 1 or 2, and M is a cation having a valence of 1 (e.g. H⁺, Na⁺, K⁺, NH₄⁺, etc.) or mixtures thereof. Preferably n is an integer from 1 to 6. Surfactants having n values greater than 6 tend to be insufficiently soluble in water to be useful in this invention, or form insoluble salts with coagulants which are difficult to wash from fluoroelastomer crumb. The dispersing agent may also be a mixture of any two or more surfactants of the above general formulae. Specific examples of surfactants which may be employed in the emulsion polymerization process of the invention include, but are not limited to CH₃—(CH₂)₃O—PO(ONa)₂; [CH₃—(CH₂)₃O]₂—PO(ONa).

One skilled in the art of fluoroelastomer preparation would not predict that a hydrocarbon surfactant of the above general formulae would be capable of stabilizing highly fluorinated (i.e. containing at least 53 wt. % fluorine) fluoroelastomer latex particles. Therefore, such a surfactant would not likely be useful in an emulsion polymerization process for manufacturing highly fluorinated fluoroelastomers. Also, hydrocarbon surfactants generally act as strong chain transfer agents (due to the large number of C—H bonds available for attack by radicals) and limit the molecular weight of polymers prepared in their presence. However, stable fluoroelastomer latex dispersions are surprisingly formed in the emulsion polymerization process of this invention which employs the above hydrocarbon surfactant as dispersing agent. Also, high molecular weight (i.e. having a number average molecular weight of 10⁶ or greater) fluoroelastomers may readily be prepared in the process of this invention.

The amount of surfactant to be employed in the aqueous emulsion polymerization solution is determined by balancing emulsion stability and polymerization rate with foam generation. If too little surfactant is used, excessive reactor fouling will occur and reaction rate may be undesirably slow. If too much surfactant is used, excessive foam will be generated and it will be difficult to remove the excess surfactant from the fluoroelastomer, thus retarding the vulcanization of the fluoroelastomer with bisphenol curatives. In an emulsion polymerization process of this invention, the amount of surfactant employed is typically 0.05 to 3 wt. %, based on the total weight of fluoroelastomer being produced. The preceding amounts are based on the amount of active ingredient, not on amount of a surfactant solution containing less that 100% active ingredient.

The emulsion polymerization process of this invention may be a continuous, semi-batch or batch process.

In the semi-batch emulsion polymerization process of this invention, a gaseous monomer mixture of a desired composition (initial monomer charge) is introduced into a reactor which contains an aqueous solution. The aqueous solution contains substantially no fluorosurfactant, i.e. less than 100 ppm by weight fluorosurfactant based on the total weight of the solution, preferably 0 ppm fluorosurfactant. The reactor is typically not completely filled with the aqueous solution, so that a vapor space remains. The aqueous solution comprises a straight chain hydrocarbon phosphate ester surfactant dispersing agent of the type discussed above. Optionally, the aqueous solution may contain a pH buffer, such as a phosphate or acetate buffer for controlling the pH of the polymerization reaction. Instead of a buffer, a base, such as NaOH may be used to control pH. Generally, pH is controlled to between 1 and 7, depending upon the type of fluoroelastomer being prepared. Alternatively, or additionally, pH buffer or base may be added to the reactor at various times throughout the polymerization reaction, either alone or in combination with other ingredients such as polymerization initiator, liquid cure site monomer, additional straight chain hydrocarbon phosphate ester surfactant or chain transfer agent. Also optionally, the initial aqueous solution may contain a water-soluble inorganic peroxide polymerization initiator. In addition, the initial aqueous solution may contain a nucleating agent, such as a fluoroelastomer seed polymer prepared previously, in order to promote fluoroelastomer latex particle formation and thus speed up the polymerization process.

The initial monomer charge contains a quantity of a first monomer of either TFE or VF₂ and one or more additional monomers which are different from the first monomer. The amount of monomer mixture contained in the initial charge is set so as to result in a reactor pressure between 0.5 and 10 MPa.

The monomer mixture is dispersed in the aqueous medium and, optionally, a chain transfer agent may also be added at this point while the reaction mixture is agitated, typically by mechanical stirring. In the initial gaseous monomer charge, the relative amount of each monomer is dictated by reaction kinetics and is set so as to result in a fluoroelastomer having the desired ratio of copolymerized monomer units (i.e. very slow reacting monomers must be present in a higher amount relative to the other monomers than is desired in the composition of the fluoroelastomer to be produced).

The temperature of the semi-batch reaction mixture is maintained in the range of 25° C.-130° C., preferably 50° C.-120° C. Polymerization begins when the initiator either thermally decomposes or reacts with reducing agent and the resulting radicals react with dispersed monomer.

Additional quantities of the gaseous major monomers and cure site monomer (incremental feed) are added at a controlled rate throughout the polymerization in order to maintain a constant reactor pressure at a controlled temperature. The relative ratio of monomers contained in the incremental feed is set to be approximately the same as the desired ratio of copolymerized monomer units in the resulting fluoroelastomer. Thus, the incremental feed contains between 25 to 70 weight percent, based on the total weight of the monomer mixture, of a first monomer of either TFE or VF₂ and 75 to 30 weight percent of one or more additional monomers that are different from the first monomer. Chain transfer agent may also, optionally, be introduced into the reactor at any point during this stage of the polymerization. Typically, additional polymerization initiator and straight chain hydrocarbon phosphate ester surfactant are also fed to the reactor during this stage of polymerization. The amount of polymer formed is approximately equal to the cumulative amount of incremental monomer feed. One skilled in the art will recognize that the molar ratio of monomers in the incremental feed is not necessarily exactly the same as that of the desired (i.e. selected) copolymerized monomer unit composition in the resulting fluoroelastomer because the composition of the initial charge may not be exactly that required for the selected final fluoroelastomer composition, or because a portion of the monomers in the incremental feed may dissolve into the polymer particles already formed, without reacting. Polymerization times in the range of from 2 to 30 hours are typically employed in this semi-batch polymerization process.

The continuous emulsion polymerization process of this invention differs from the semi-batch process in the following manner. The reactor is completely filled with aqueous solution so that there is no vapor space. Gaseous monomers and solutions of other ingredients such as water-soluble monomers, chain transfer agents, buffer, bases, polymerization initiator, surfactant, etc., are fed to the reactor in separate streams at a constant rate. Feed rates are controlled so that the average polymer residence time in the reactor is generally between 0.2 to 4 hours. Short residence times are employed for reactive monomers, whereas less reactive monomers such as perfluoro(alkyl vinyl)ethers require more time. The temperature of the continuous process reaction mixture is maintained in the range of 25° C.-130° C., preferably 80° C.-120° C. Also, fluoroelastomer latex particles are more readily formed in the continuous process so that a nucleating agent is not typically required in order to start the polymerization reaction.

In the process of this invention, the polymerization temperature is maintained in the range of 25°-130° C. If the temperature is below 25° C., the rate of polymerization is too slow for efficient reaction on a commercial scale, while if the temperature is above 130° C., the reactor pressure required in order to maintain polymerization is too high to be practical.

The polymerization pressure is controlled in the range of 0.5 to 10 MPa, preferably 1 to 6.2 MPa. In a semi-batch process, the desired polymerization pressure is initially achieved by adjusting the amount of gaseous monomers in the initial charge, and after the reaction is initiated, the pressure is adjusted by controlling the incremental gaseous monomer feed. In a continuous process, pressure is adjusted by a back-pressure regulator in the dispersion effluent line. The polymerization pressure is set in the above range because if it is below 1 MPa, the monomer concentration in the polymerization reaction system is too low to obtain a satisfactory reaction rate. In addition, the molecular weight does not increase sufficiently. If the pressure is above 10 MPa, the cost of the required high pressure equipment is very high.

The amount of fluoroelastomer copolymer formed is approximately equal to the amount of incremental feed charged, and is in the range of 10-30 parts by weight of copolymer per 100 parts by weight of aqueous medium, preferably in the range of 20-25 parts by weight of the copolymer. The degree of copolymer formation is set in the above range because if it is less than 10 parts by weight, productivity is undesirably low, while if it is above 30 parts by weight, the solids content becomes too high for satisfactory stirring.

Water-soluble peroxides which may be used to initiate polymerization in this invention include, for example, the ammonium, sodium or potassium salts of hydrogen persulfate. In a redox-type initiation, a reducing agent such as sodium sulfite, is present in addition to the peroxide. These water-soluble peroxides may be used alone or as a mixture of two or more types. The amount to be used is selected generally in the range of 0.01 to 0.4 parts by weight per 100 parts by weight of polymer, preferably 0.05 to 0.3. During polymerization some of the fluoroelastomer polymer chain ends are capped with fragments generated by the decomposition of these peroxides.

Optionally, fluoroelastomer gum or crumb may be isolated from the fluoroelastomer dispersions produced by the process of this invention by the addition of a coagulating agent to the dispersion. Any coagulating agent known in the art may be used. Preferably, a coagulating agent is chosen which forms a water-soluble salt with the surfactant contained in the dispersion. Otherwise, precipitated surfactant salt may become entrained in the isolated fluoroelastomer and then retard curing of the fluoroelastomer with bisphenol-type curatives.

In one isolation process, the fluoroelastomer dispersion is adjusted to a pH less than 4 and then coagulated by addition of an aluminum salt. Undesirable insoluble aluminum hydroxides form at pH values greater than 4. Aluminum salts useful as coagulating agents include, but are not limited to aluminum sulfate and alums of the general formula M′Al(SO₄)₂12H₂O, wherein M′ is a univalent cation, other than lithium. The resulting coagulated fluoroelastomer may then be filtered, washed and dried.

In addition to aluminum salts, common coagulants such as calcium salts (e.g. calcium nitrate) or magnesium salts (e.g. magnesium sulfate), and some salts of univalent cations (e.g. sodium chloride or potassium chloride), may be employed to coagulate fluoroelastomers.

Another aspect of this invention is the curable fluoroelastomers that are produced by the process of this invention. Such fluoroelastomers are generally molded and then vulcanized during fabrication into finished products such as seals, wire coatings, hose, etc. Suitable vulcanization methods employ, for example, polyol, polyamine, organic peroxide, organotin, bis(aminophenol), tetraamine, or bis(thioaminophenol) compounds as curatives.

The fluoroelastomers prepared by the process of this invention are useful in many industrial applications including seals, wire coatings, tubing and laminates.

### EXAMPLES

### Test Methods

Mooney viscosity, ML (1+10), was determined according to ASTM D1646 with an L (large) type rotor at 121° C., using a preheating time of one minute and rotor operation time of 10 minutes.

Inherent viscosities were measured at 30° C. Methyl ethyl ketone was employed as solvent (0.1 g polymer in 100 ml solvent).

The invention is further illustrated by, but is not limited to, the following examples.

### Example 1

A VF₂/HFP copolymer fluoroelastomer was prepared by a continuous emulsion polymerization process of the invention, carried out at 115° C. in a well-stirred 2.0-liter stainless steel liquid full reaction vessel. An aqueous solution, consisting of 2.18 g/hour (g/h) ammonium persulfate initiator, 3.50 g/h ammonium hydroxide, 1.39 g/h Hordaphos® MDB surfactant (available from Clariant), and 2.10 g/h isopropanol chain transfer agent in deionized water, was fed to the reactor at a rate of 5 L/hour. The reactor was maintained at a liquid-full level at a pressure of 6.2 MPa by means of a backpressure control valve in the effluent line. After 30 minutes, polymerization was initiated by introduction of a gaseous monomer mixture consisting of 769 g/h vinylidene fluoride (VF₂), and 575 g/h hexafluoropropylene (HFP), fed through a diaphragm compressor. After 2.0 hours, collection of effluent dispersion was begun and collection continued for 5 hours. The effluent polymer dispersion, which had a pH of 3.52 and contained 19.6 wt. % solids, was separated from residual monomers in a degassing vessel at atmospheric pressure. Fluoroelastomer polymer was isolated using calcium nitrate coagulant solution. The coagulated polymer was allowed to settle, supernatant serum was removed, and the polymer was washed by reslurrying in water two times before filtering. The wet crumb was dried in an air oven at approximately 50°-65° C. to a moisture content of less than 1%. About 6.0 kg of polymer was recovered at an overall conversion of 93.5%. The product, comprised of 61.9 wt. % VF₂ units and 38.1 wt. % HFP units, was an amorphous elastomer having a glass transition temperature of −20.5° C., as determined by differential scanning calorimetry (heating mode, 10° C./minute, inflection point of transition). Inherent viscosity of the elastomer was 0.63 dL/g, measured at 30° C. in methyl ethyl ketone, and Mooney viscosity, ML(1+10), was 32.

### Example 2

A VF₂/HFP/TFE copolymer fluoroelastomer was prepared by a continuous emulsion polymerization process of the invention, carried out at 110° C. in a well-stirred 2.0-liter stainless steel liquid full reaction vessel. An aqueous solution, consisting of 2.16 g/hour (g/h) ammonium persulfate, 3.50 g/h ammonium hydroxide, 1.21 g/h Hordaphos® MDB surfactant, and 0.98 g/h isopropanol in deionized water, was fed to the reactor at a rate of 5 L/hour. The reactor was maintained at a liquid-full level at a pressure of 6.2 MPa by means of a backpressure control valve in the effluent line. After 30 minutes, polymerization was initiated by introduction of a gaseous monomer mixture consisting of 395 g/h vinylidene fluoride (VF₂), 507 g/h hexafluoropropylene (HFP), and 309 g/h tetrafluoroethylene (TFE) fed through a diaphragm compressor. After 2.0 hours, collection of effluent dispersion was begun and collection continued for 4 hours. The effluent polymer dispersion, which had a pH of 3.29 and contained 18.5 wt. % solids, was separated from residual monomers in a degassing vessel at atmospheric pressure. Fluoroelastomer product was isolated using calcium nitrate solution coagulant. The coagulated polymer was allowed to settle, supernatant serum was removed, and the polymer was washed by reslurrying in water two times before filtering. The wet crumb was dried in an air oven at approximately 50°-65° C. to a moisture content of less than 1%. About 4 kg of polymer was recovered at an overall conversion of 91.6%. The product, comprised of 37.3 wt. % VF₂ units, 36.7 wt. % HFP units, and 27.7 wt. % TFE units, was an amorphous elastomer having a glass transition temperature of −8.5° C., as determined by differential scanning calorimetry (heating mode, 10° C./minute, inflection point of transition). Inherent viscosity of the elastomer was 0.52 dL/g, measured at 30° C. in methyl ethyl ketone, and Mooney viscosity, ML(1+10), was 66.

### Example 3

A VF₂/TFE/PMVE copolymer fluoroelastomer was prepared by a continuous emulsion polymerization process of the invention, carried out at 105° C. in a well-stirred 2.0-liter stainless steel liquid full reaction vessel. An aqueous solution, consisting of 2.13 g/hour (g/h) ammonium persulfate, 3.50 g/h ammonium hydroxide, and 1.11 g/h Hordaphos® MDB surfactant, was fed to the reactor at a rate of 5 L/hour. The reactor was maintained at a liquid-full level at a pressure of 6.2 MPa by means of a backpressure control valve in the effluent line. After 30 minutes, polymerization was initiated by introduction of a gaseous monomer mixture consisting of 569 g/h vinylidene fluoride (VF₂), 101.5 g/h tetrafluoroethylene (TFE), and 393 g/h perfluoro(methyl vinyl ether) (PMVE) fed through a diaphragm compressor. After 400 g of the latter monomer mixture had been reacted, a stream of BTFB cure site monomer was fed to the reactor at the rate of 1.2% of the rate of gaseous monomer mixture feed. After 2.0 hours, collection of effluent dispersion was begun and collection continued for 4 hours. The effluent polymer dispersion, which had a pH of 6.40 and contained 20.9 wt. % solids, was separated from residual monomers in a degassing vessel at atmospheric pressure. Fluoroelastomer product was isolated using calcium nitrate solution coagulant. The coagulated polymer was allowed to settle, supernatant serum was removed, and the polymer was washed by reslurrying in water two times before filtering. The wet crumb was dried in an air oven at approximately 50°-65° C. to a moisture content of less than 1%. About 4 kg of polymer was recovered at an overall conversion of 95.9%. The product, comprised of 54.5 wt. % VF₂ units, 8.9 wt. % TFE units, 34.6 wt % PMVE units, and 2.0 wt % BTFB units, was an amorphous elastomer having a glass transition temperature of −31.1° C., as determined by differential scanning calorimetry (heating mode, 10° C./minute, inflection point of transition). Inherent viscosity of the elastomer was 1.30 dL/g, measured at 30° C. in methyl ethyl ketone, and Mooney viscosity, ML(1+10), was 92.

### Example 4

A VF₂/HFP copolymer fluoroelastomer was prepared by a semi-batch emulsion polymerization of the invention, carried out at 80° C. in a well-stirred reaction vessel. A 33-liter, horizontally agitated reactor was charged with 23968.1 grams of deionized, deoxygenated water, 24.0 g of Hordaphos® MDB surfactant and 7.9 g of sodium hydroxide. The reactor was heated to 80° C. and then pressurized to 1.38 MPa with a mixture of 38.0 wt % VF₂ and 62.0 wt. % HFP. A 550 ml aliquot of a 10 wt. % ammonium persulfate initiator solution was then added. A gaseous monomer mixture of 60.0% wt. % VF2 and 40 wt % HFP was fed to the reactor in order to maintain a pressure of 1.38 MPa throughout the polymerization. After a total of 6000 g monomer mixture had been supplied to the reactor, monomer addition was discontinued and the reactor was purged of residual monomer. The total reaction time was 5 hours. The resulting emulsion was coagulated by addition of aluminum sulfate solution and the decanted polymer washed with deionized water. The polymer crumb was dried for two days at 60° C. The product, comprised of 59.6 wt. % VF2 units and 40.4 wt. % HFP units was an amorphous elastomer. Inherent viscosity of the elastomer was 0.55 dL/g, measured at 30° C. in methyl ethyl ketone, and Mooney viscosity, ML(1+10), was 21.5.

What is claimed is:

1. An emulsion polymerization process for producing a fluoroelastomer, said fluoroelastomer having at least 53 weight percent fluorine, comprising:
(A) charging a reactor with a quantity of an aqueous solution comprising a phosphate ester anionic surfactant of the formula [CH₃—(CH₂)ₙ—O]ₓ—PO(OM)₍₃₋ₓ₎ wherein n is an integer from 1 to 8, or mixtures thereof, x is 1 or 2, and M is a cation having a valence of 1, said aqueous solution containing less than 100 ppm fluorosurfactant;
(B) charging the reactor with a quantity of a monomer mixture, said monomer mixture comprising i) from 25 to 70 weight percent, based on total weight of the monomer mixture, of a first monomer, said first monomer selected from the group consisting of vinylidene fluoride and tetrafluoroethylene, and ii) between 75 and 30 weight percent, based on total weight of the monomer mixture, of one or more additional copolymerizable monomers, different from said first monomer, wherein said additional monomer is selected from the group consisting of fluorine-containing olefins, fluorine-containing vinyl ethers, hydrocarbon olefins and mixtures thereof; and
(C) polymerizing said monomers in the presence of a free radical initiator to form a fluoroelastomer dispersion while maintaining said reaction medium at a pH between 1 and 7, at a pressure between 0.5 and 10 MPa, and at a temperature between 25° C. and 130° C.

2. The emulsion polymerization process of claim 1 wherein said phosphate ester anionic surfactant is selected from the group consisting of CH₃—(CH₂)₃O—PO(ONa)₂; and [CH₃—(CH₂)₃O]₂—PO(ONa).

3. The emulsion polymerization process of claim 1 further comprising (D) isolating fluoroelastomer from said dispersion by addition of a coagulating agent.

4. The emulsion polymerization process of claim 3 wherein said coagulating agent is a salt having a cation selected from the group consisting of Al³⁺, Ca²⁺, Mg²⁺ and univalent cations.

5. The emulsion polymerization process of claim 1 further comprising charging said reactor with a cure site monomer.

6. The emulsion polymerization process of claim 1 further comprising charging said reactor with a chain transfer agent.

7. The emulsion polymerization process of claim 1 wherein said fluoroelastomer comprises copolymerized monomer units selected from the group consisting of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl)ether, ethylene and 4-iodo-3,3,4,4-tetrafluorobutene-1; xi) tetrafluoroethylene, propylene and vinylidene fluoride; xii) tetrafluoroethylene and perfluoro(methyl vinyl)ether; xiii) tetrafluoroethylene, perfluoro(methyl vinyl)ether and perfluoro(8-cyano-5-methyl-3,6-dioxa-1-octene); xiv) tetrafluoroethylene, perfluoro(methyl vinyl)ether and 4-bromo-3,3,4,4-tetrafluorobutene-1; xv) tetrafluoroethylene, perfluoro(methyl vinyl)ether and 4-iodo-3,3,4,4-tetrafluorobutene-1; and xvi) tetrafluoroethylene, perfluoro(methyl vinyl)ether and perfluoro(2-phenoxypropyl vinyl)ether.
